(19) United States
(12) Patent Application Publication
(10) Pub. No.: US 2021/0207611 A1
(43) Pub. Date: Jul. 8, 2021

(54) Airflow amplifier device for testing purpose

(71) Applicant: VIETTEL GROUP, Ha Noi City (VN)

(72) Inventors: QUANG HAI NGUYEN, Ha Noi City (VN); CONG ANH PHAM, Xuan Truong District (VN); XUAN LONG BUI, Ha Noi City (VN); TUAN ANH PHAM, Ha Noi City (VN)

(73) Assignee: VIETTEL GROUP, Ha Noi City (VN)

(21) Appl. No.: 16/920,588

(22) Filed: Jul. 3, 2020

(30) Foreign Application Priority Data
Jan. 2, 2020 (VN) 1-2020-00035

(51) Int. Cl. F04D 27/00; G01M 9/06

(52) U.S. Cl. CPC F04D 27/003; G01M 15/14; G01M 9/065

(57) ABSTRACT

The invention provides a solution to amplify the airflow for testing purpose; this solution could be conventionally set up and configured with simple components or popular industrial systems. It is particularly interesting for small facilities/companies with limited resources or demanding only a low investment. This system is consisted of a high pressure air driving duct, an air mixing duct, a pressure reduction valve and a safety valve, ducts' size can be configured or changed to adapt the testing configuration. All components and systems are connected and attached to each other by stainless steel flanges and seals to avoid leakage and corrosion.

### TECHNICAL DISCIPLINE SPECIFICATION

This invention relates to the amplification system of airflow for testing purpose. Its application could be found in different testing which relies on the air compression system, in particular for gas turbine engine such as providing airflow for combustion testing or engine's compressor, as well as simulating airflow of real flight conditions.

### BACKGROUND OF THE INVENTION

Compressed air is a mandatory part in manufacturing facilities, industry factories and research units in different fields (mechanical, automotive, aerospace, energy, etc.) with application found in various fields. Compressed air system is particularly used for testing of aerodynamic behavior of in-flight objects. With a fixed object, the simulated airflow could help provide the impact of airflow upon the object, and also aerodynamic behavior of this surrounding airflow.

To build a model for the aerodynamic testing, aerospace and automotive industries generally own modern and sophisticated facilities with an appropriate and stable compressed air source. For example in the testing of gas turbine combustion, it requires a complete installation with compressed air generation to provide exactly the working condition of the combustion chamber such as a high airflow rate at high pressure and high temperature simulating the airflow coming out of the front compressor. This compressed air source is managed by a regulation system with reduction valves, safety valves and control system to ensure safe and efficient operations. Such a high quantity of airflow in this example is a big challenge for small institutions since it requires a complex facility dealing with high pressure compression system, storage system and distribution system of the compressed air, together with a high power supply (using specific electricity grid or dedicated generator machine) to provide enough power to maintain the whole system.

The airflow amplifier addressed in this invention can be used to convert the high pressure compressed air to lower pressure but higher volume rate airflow. This conversion is particularly interesting for testing purposes of flight simulation for aeronautic objects like airplane, engine and combustion chamber, etc. The airflow is required to be as uniform as possible in term of flow streamline, volume rate and pressure to be most compliant with the testing's purpose. This invention will provide also a method to flexibly generate different natures of airflow (pressure and volume rate) for different testing purposes respectively.

### Technical Principle of the Invention

The invention provides an amplifier system of airflow for testing purpose, which could be easily deployed in small institutions and research centers with limited testing capabilities, keeping however meeting all specifications of the required testing's request. It could be particularly useful for small companies/institutions/schools in demonstration/learning/R&D projects with very low financial investment.

The system is consisted of several main components as: high compressed air driving duct, air mixing duct, pressure reduction valve and safety valve. These components are further described as follows:

High pressure air driving duct is a part used to squeeze the high pressure, it is made of a metal material resistant to high pressure, one end of this duct is of a smaller cross-section which has diameter A1≤33.8 mm and can be replayed by the same one with other diameter A1. The middle part is a cylindrical tube with a diameter equal to that of the high-pressure gas pipe from the pneumatic system. The other end of the driving duct is a circular cross-section duct which is the flange to screw in connection with the other components of the system.

Air mixing duct is a metal circular empty duct whose diameter can be changed. It is set concentrically with the conical duct device, both placed horizontally. One end of the mixing duct is connected with the conical duct by flanges and it covers completely the conical duct. Like the driving duct, it is made of a metal material resistant to air pressure and temperature as well as corrosion.

Pressure reduction valve has the characteristics of being subject to larger pressures of high pressure current.

Safety valve is used to maintain the pressure level in the driving duct, avoiding unexpected over pressure issue within the system. The safety valve is connected to the driving duct by a T-duct and fixed by appropriate flanges and seals to ensure a no-leakage in the system.

Airflow amplifier device for testing purpose to proposed invention, wherein the high-pressure air duct conducts compressed air from the compressed air system into test houses by heat-resistant, high performance and anti-rust aluminum alloy pipelines.

Airflow amplifier device for testing purpose to proposed invention, wherein the pressure reduction valve and safety valve will be connected by steel flanges and heat-resistant rubber seals to ensure safety and discreetness for systems to avoid compressed air leakage.

### DESCRIPTION OF FIGURES

FIG. 1: Airflow amplifier device principle and example of a testcase

FIG. 2: Simulation result of Mach number

FIG. 3: Simulation of total pressure

FIG. 4: Simulation of air mass flow rate

FIG. 5: High pressure air driving duct

FIG. 6: Air mixing duct

FIG. 7: Overall installation of the air amplifier device

### DETAILED DESCRIPTION OF THE INVENTION

The invention provides a solution of air amplifier device for testing purpose which is to be deployed along with an air compression system (typically a common industrial air compressor).

Air compression system plays an important role in the whole amplifier system. Air compression system is generally also crucial in all industries such as pharmacy, food, aeronautics, automotive, etc. Air compressor is therefore a very common system and can be easily found in the industry supply market.

In reality, the air compressor is also used for different purposes of the same business unit (institution, school, small company), covering different needs of compressed air sources like facility compressed air, balancing compressed air, starting compressed air, small wind tunnel, etc. It is therefore a compromise to all these requisites from different purposes. The air compressor considered in this invention is a very popular one in the market with the capability of providing an air flow at a volume rate of 2-3 kg/s and at a pressure of about 10 atm.

The candidate testing object used in this invention is the combustion chamber of a small gas turbine engine, which needs an air flow at a flow rate up to 8 kg/s and at a pressure from 1.3 atm to 5 atm. Normally, it would need 2 distinct systems to serve the above testing exercise, this invention provides however a possibility to cover the given range of testing capabilities only with the common air compressor considered above (2-3 kg/s at 10 atm air compressor).

The high-pressure air duct is a part to connect the pneumatic system and a flow amplification system according to the proposed invention.

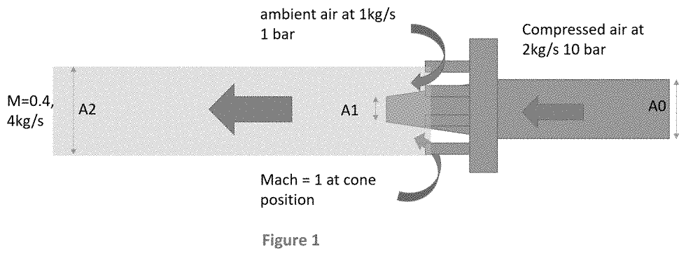

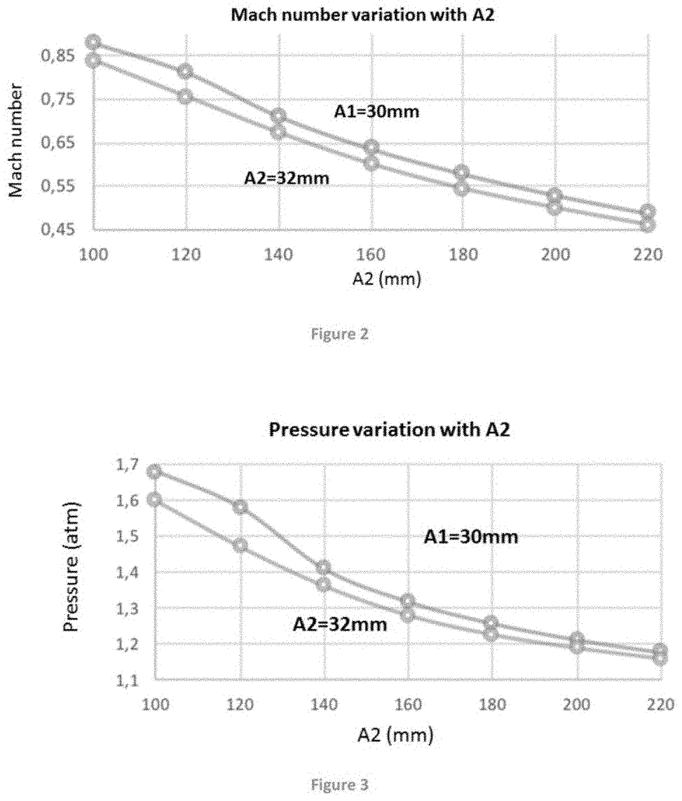

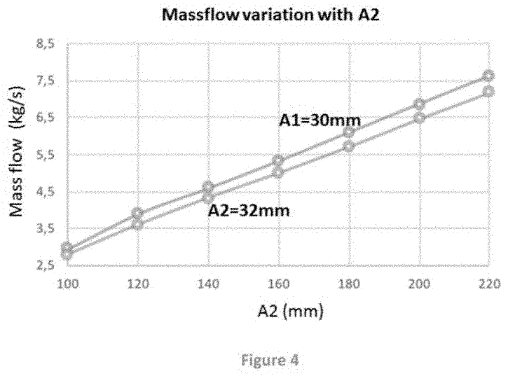

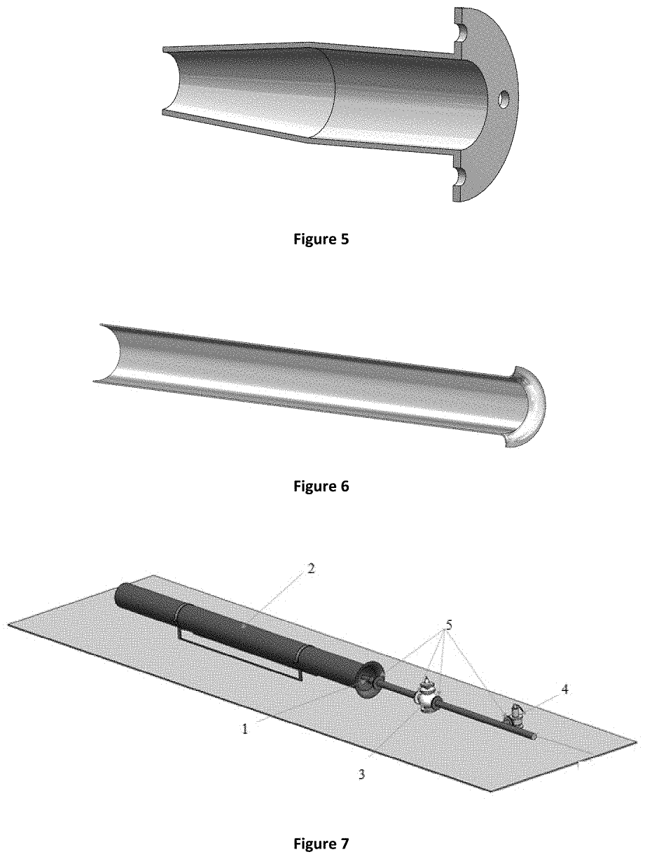

According to the FIG. 1, the airflow amplifier device for testing purpose is consisted of: High pressure air driving duct, air mixing duct, pressure reduction valve and safety valve.

The conical end of the high pressure air driving duct is a device to tighten the upcoming high pressure compressed air to intentionally create the “choke” phenomenon at the exit area of the conical end (i.e. the Mach number at this position is driven to be 1). The choked high-pressure air at the entrance of the mixing duct will make the surrounding airflow enter to create a higher volume rate, this additional airflow entering the mixing duct from the outside is also called “induced flow”. The Mach number of 1 at the exit area of the conical end of the driving duct (also at the entrance of the mixing duct) is intentionally aimed to maximize the quantity of total airflow to enter the mixing duct. While maintaining the choke phenomenon at this position, we can then adjust the exit area (concretely the diameter A1) of the driving duct or the inlet area (concretely the diameter A2) of the mixing duct. The choice and combination of A1 and A2 can help us create an air mass flow as pre-requested.

The air massflow rate at the exit area of the driving duct, at choking condition is:

$${m}^{′} = 0.0404 * \frac{P}{\sqrt{T}} * A \qquad ( 1 )$$

In which:

m′: mass flow rate at choking condition;

P: Total pressure of the air source;

T: Total temperature of the air source;

A: Cross-section area of the duct;

With the chosen air compression system as mentioned above, m′=2 kg/s, total pressure P=1013250 Pa and total temperature T=333K. Applying these in (1) we have the maximum cross-section area of the driving duct to still have choke phenomenon is A=8.969.10⁻⁴ m².

Assuming A1 is the diameter of the high-pressure gas nozzle and A2 is the diameter of gas-mixing tube 2, we have:

Method of calculating the area of the high-pressure gas nozzle: A=π×A1².

With A=8.969×10⁻⁴ m², we have A1≤33.8 mm, there will be phenomenon of “choking air” at the mouth of the air pipe.

The pressure in the pipe is quite high, so the required material for the pipe must be high pressure resistance material. The detachable high pressure air driving duct 1 is easily replaced to create suitable air parameters for the different test conditions.

In reality, the conical end of the driving duct (with A1 diameter in the one end, and another higher diameter in another end) can be changed by adapting the diameter A1 according the incoming flow to fully meet the specific testing configuration. The other end of the duct is a circular duct having the same diameter than outflow duct of the air compressor. The conical duct has a length of 1000 mm, a diameter of A1 in one side connecting with the mixing duct, and another diameter of 50.8 mm which is also the diameter of the circular duct to be attached with the air compressor's outflow duct.

The mixing duct is a metal circular duct, its size can be adjusted to adapt the incoming flow from the driving duct in order to provide the aimed air flow rate for a given testing purpose, bigger duct's cross-section's size leads naturally to higher mixed air flow. The duct end which is in connection with the driving duct is designed to be a divergent nozzle-type to facilitate the flow path while being mixed. The diameter of nozzle diameter is estimated here of 50 mm.

The driving duct and the mixing duct are place concentrically in a horizontal plane, with the conical tube of the driving duct to be placed completely inside the mixing duct, with a certain depth creating an empty space between the 2 items. This empty space being open to with the outside will allow the external airflow to come into the mixing duct, under the induction effect generated by choked flow (relatively high pressure and velocity) issued by the driving duct. Preliminary verification confirms that a length of 3 m of the mixing duct is enough for the 2 flow sources to be completely mixed to provide uniform outflow.

The mixing duct is fixed to the whole testing rig by metal bolted flanges; it can be easily replaced for ones of other sizes to change the flow configuration for each specific testing condition.

The pressure reduction valve has the objective to lower the pressure from high pressure flow to better adapt the testing configuration. This is a common industrial device, attention needs to be made to ensure the working pressure of the valve must be in line with the operating pressure we are dealing with in the system.

The safety valve is used to maintain the flow in the driving duct to always stay under an acceptable level, ensuring the absolute safety during the testing operation. Like the pressure reduction valve, the safety valve's working pressure must be in line with the given operating pressure.

Refer to the FIG. 1, airflow amplifier device for testing purpose, where in the bulky and complex compressed air system will be arranged separately in the container and direct the compressed air from the compressed air system to the test houses by heat resistance, high pressure and rust resistance aluminum alloy pipe. Refer to the FIG. 7, which illustrates facility setup with driving duct (1), air mixing duct (2), pressure reduction valve (3), safety valve (4), flanges and seals (5), the whole system is briefly described as follows: The high pressure flow will first pass by a safety valve (4), this valve (4) is connected with the whole system by the T-duct which is fixed by bolted flange (5) with appropriate rubber seal to avoid leakage. The valve (4) will ensure that the flow pressure stays always in controlled limit. The flow will then pass by the pressure reduction valve (3) to regulate the flow pressure to a required level. The flow will continue going to the driving duct with a conical end (1) where the choke will occur. All connections between components are ensured by bolted steel flanges with sealing system to ensure a complete no-leakage.

### Example of an Application of Invention

After determining all necessary parameters of the air flow requested by the given test, a configuration of the system will be chosen and setup accordingly. The main idea of this system is to convert the high pressure airflow at small flow rate to a lower pressure airflow at a higher flow rate. The exact flow parameters (velocity, mass flow rate) can be configured by changing the section's diameter A1 of the conical end of the driving duct and diameter A2 of the mixing duct.

A simulation with A1=30 mm and 32 mm (both provide choking phenomenon) is carried on, each A1 with an option of A2 varying from 100 mm to 220 mm. The consequent results provide the flow coming out of the mixing duct vary from 26 kg/s to 7.5 kg/s (corresponding to Mach from 0.45 to 0.90 and total pressure from 1.5 atm to 1.7 atm). With the given air compressor, this will provide an overall operation map of this device, from which we can determine back the most appropriate A1 and A2 to reach the flow's requirement.

### The Benefits that the Invention Achieves

In terms of science, the invention offers a flexible method to customize high-pressure air streams into different air streams to suit the test in the field of aerospace.

In terms of facilities, the invention saves a financial source, can perform a number of tests on the limited infrastructure and finance.

1. Airflow amplifier device for testing purpose consisting of high pressure air driving duct, air mixing duct, pressure reduction valve and safety valve, described as follows:
High pressure air driving duct is a part used to squeeze the high pressure, it is made of a metal material resistant to high pressure, one end of this duct is of a smaller cross-section which has diameter A1≤33.8 mm and can be replayed by the same one with other diameter A1. The middle part is a cylindrical tube with a diameter equal to that of the high-pressure gas pipe from the pneumatic system. The other end of the driving duct is a circular cross-section duct which is the flange to screw in connection with the other components of the system.
An Air mixing duct comprising a metal circular empty duct whose diameter is A2 which is bigger than A1, It is set concentrically with the above conical duct device, both placed horizontally, Like the driving duct, it is made of a metal material resistant to air pressure and temperature as well as corrosion;
Pressure reduction valve has the characteristics of being subject to larger pressures of high pressure current.
A Safety valve is used to maintain the pressure level in the driving duct, avoiding unexpected over pressure issue within the system. The safety valve is connected to the driving duct by a T-duct and fixed by appropriate flanges and seals to ensure a no-leakage in the system.

2. The Airflow amplifier device according to claim 1, wherein said ducts are made of pressure resistant and corrosion-free metal Alloy to bring and distribute the high pressure airflow from the air compressor, wherein the air compressor is placed in an isolated area according to industrial standards.

3. The Airflow amplifier device according to claim 1, further comprising Systems of connection flanges made of stainless steel, and system of rubber seal to ensure safety and no-leakage, no-corrosion of the system.
